(19) United States
(12) Patent Application Publication
(10) Pub. No.: US 2014/0089068 A1
(43) Pub. Date: Mar. 27, 2014

(54) Videos for In Application Purchases and Rewards for Sharing Same through Social Media and Video Advertising for Reengagement

(71) Applicants: Shlomo Yehezkel, Mercer Island, WA (US); Paulo Brandao, Los Angeles, CA (US); Ty Heath, Monroe, WA (US); David Kurtz, Redwood City, CA (US)

(72) Inventors: Shlomo Yehezkel, Mercer Island, WA (US); Paulo Brandao, Los Angeles, CA (US); Ty Heath, Monroe, WA (US); David Kurtz, Redwood City, CA (US)

(73) Assignee: Jirbo, Inc., Los Angeles, CA (US)

(21) Appl. No.: 14/031,264

(22) Filed: Sep. 19, 2013

Related U.S. Application Data
(60) Provisional application No. 61/786,786, filed on Mar. 15, 2013.
(60) Provisional application No. 61/705,442, filed on Sep. 25, 2012.

(51) Int. Cl. G06Q 30/02

(52) U.S. Cl. CPC G06Q 30/0217
USPC 705/14.19

(57) ABSTRACT

The present invention is directed to the systems, computer program products, methods and devices that encourage users of applications for mobile devices to watch and/or to share videos. In some embodiments, users are provided with the opportunity to purchase goods or services in exchange for having viewed a video within the context of an application. These users may also be provided with the opportunity to purchase goods or services in exchange for sharing the videos through social media. Alternatively od additionally, they may be presented with opportunities for reengaging applications that they previously used but for which they have decreased the frequency with which they use those applications or have ceased using those applications.

### CROSS-REFERENCE TO RELATED APPLICATIONS

This application claims the benefit of the filing dates of U.S. Provisional Application Ser. No. 61/705,442, filed Sep. 25, 2012 and U.S. Provisional Application Ser. No. 61/786,786, filed Mar. 15, 2013, the entire disclosures of which are incorporated by reference as if set forth fully herein.

### FIELD OF THE INVENTION

The present invention is directed to video advertising.

### BACKGROUND OF THE INVENTION

As consumers increasingly rely on their wireless devices, vendors and service providers in turn increasingly search for means by which to encourage consumers to learn about their goods and services. Among the methods that have been tried in the past are pop-up and banner advertisements. These methods have proven effective to some degree for targeting consumers who surf the internet and jump from website to website.

However, many consumers now spend less time surfing the internet and more time within applications, such as consumer games that are loaded on their smart phones. Additionally, many users change the amount of time that they spend within particular applications, and over time for some of those applications users become sporadically active, rarely active or completely inactive.

For advertisers, these trends present at least four challenges: (1) how to reach consumers while they are within applications; (2) how to encourage consumers to devote time to learn about offerings: (3) if a user is known to use an application but the user becomes inactive in that application, how to locate the inactive user while in another application and to continue to advertise to them; and (4) how to encourage inactive users to reengage within their inactive applications. Various embodiments of the present invention are directed to one or more of these issues.

### SUMMARY OF THE INVENTION

Various embodiments of the present invention provide methods, systems, computer program products and devices that incentivize consumers to view video advertisements and/or that facilitate the reengagement of users with applications that may or may not be configured to incentivize consumers to view video advertisements. Through the use of one or more of the embodiments of the present invention, marketers can deliver videos to consumers with increased likelihood of having consumers view these videos, and/or tap into consumers' networks of contacts by encouraging them to share the videos and/or cause consumers to reengage in applications that they are using with a decreased frequency. In many embodiments, users may have a more satisfactory experience when executing videos within applications and/or sharing the videos because they can obtain goods and services in exchange for their time. Additionally, in some applications, consumers can be reminded of the availability of applications that they had previously used, some of which may be available in newer versions or with updates relative to what the consumer previously used.

According to one embodiment, the present invention provides a method for obtaining a reward in exchange for displaying a video on a mobile device. The method comprises: (a) displaying an in-application payment advertisement on a mobile device within an application; (b) transmitting a purchase request to a first server, wherein the purchase request comprises data that corresponds to confirmation that the in-application payment advertisement has been displayed on the device; (c) receiving a purchase response from the first server, wherein the purchase response confirms that distribution of a reward may proceed; and (d) receiving the reward on the mobile device from a second server.

Prior to displaying the in-application payment advertisement on the mobile device, the method may further comprise: (a) transmitting a request for an in-application payment advertisement from the mobile device to a third server, wherein the third server comprises or is operably coupled to a database that comprises one or more in-application payment advertisements; and (b) receiving the in-application payment advertisement on the mobile device. In the methods described above, three servers are referenced; however, as a person of ordinary skill in the art will recognize, any two or all three servers' functions could be performed by different modules within a single server.

According to a second embodiment, the present invention provides a mobile device for the delivery of video advertisements within an application. The device comprises a computer program product stored in a non-transitory medium, wherein the computer program product comprises: (a) a manager module, wherein the manager module is configured to interact with an application and to prepare a request for a data file, wherein the request comprises information corresponding to a zone for a video advertisement within the application; (h) a downloader module, wherein the downloader module is configured to send the request to a remote server that is an ad server, and to receive in response to the request an ad file that comprises ad data and media assets for an in-application payment advertisement; (c) a playback module, wherein the playback module is configured to cause the mobile device to display a video that corresponds to the in-application payment advertisement; (d) a purchase request module, wherein the purchase request module is configured to transmit a purchase request to a purchase server; (e) a purchase receipt module, wherein the purchase receipt module is configured to receive a validity and success response from the purchase server after the device has displayed an in-application video; and (f) a completion of transaction module, wherein the completion of transaction module in configured to communicate with a remote reward provider and to receive a reward from the remote reward provider.

According to a third embodiment, the present invention provides a system for providing a reward for viewing a video in an application. The system comprises: (a) a first server, wherein the first server is an ad server, that comprises or is operably coupled to a database comprising one or more in-application payment advertisements and the ad-server is configured to receive a request from a mobile device, wherein the request comprises one or more playback feature requirements; (b) the mobile device, wherein the mobile device is capable of wirelessly communicating with the first server; and (c) a second server, wherein the second server is a purchase server, wherein the purchase server is configured to receive communications from the wireless device and to verify whether a reward is available for viewing the in-application payment advertisement. Optionally, the system comprises a third server that is capable of delivering the reward to the mobile device.

According to a fourth embodiment, the present invention provides a method for obtaining a reward comprising: (a) causing a mobile device to display a video within an application; (b) selecting a set of targets from a contacts database; (c) providing access to the video to the set of targets through a social-networking application; and (d) receiving a reward after (c).

According to a fifth embodiment, the present invention provides a method for targeting and reengaging inactive users of an application, said method comprising: (a) identifying a segment of users who are less active than the users were at a previous time; (b) transmitting a reengagement video to the set of users; (c) offering a reengagement action to the set users; and (d) enabling the users to activate the reengagement action.

According to a sixth embodiment, the present invention provides a system for segmenting and targeting inactive users of an application or a subset of users of an application, said system comprising: (a) a first server, wherein the first server is an ad server that comprises or is operably coupled to a database comprising user segments of active and inactive users of one or more applications and the ad-server is configured to receive a request from a wireless device, wherein the request comprises one or more playback feature requirements and the ad server is capable of targeting re-engagement campaigns to users who have been inactive with respect to said one or more applications; (b) the wireless device, wherein the wireless device is capable of wirelessly communicating with the first server, information that comprises an identifier that can be matched against the database of user segments; and (c) a second server, wherein the second server is an event server, wherein the event server is configured to receive communications from the wireless device and to verify whether an application has been reinstalled, updated, or opened.

According to a seventh embodiment, the present invention provides a method for segmenting users, said method comprising: receiving first-party data, wherein the first-party data comprises one or more of usage logs and events and in-app purchase data; (a) receiving a unique identifier for each user; (b) segmenting a plurality of users into a set of active users and a set of inactive users to form segmented sets of users; and (c) further segmenting users by the unique identifier of each user within either or both the set of active users and the set of inactive users based on at least one of average usage over a time period or in-app purchase history to form further segmented sets of users.

As the value of having consumers engage with mobile applications steadily increases through a combination of advertising revenue based on reach and in-app purchases, maintaining a loyal base of daily and monthly active users will be critical for the success of application publishers. Various embodiments, such as the fifth, sixth and seventh embodiments, of the present invention will enable application publishers to efficiently target application users and/or to reengage targeted application users.

Thus, through various embodiments of the present invention a consumer can directly accrue goods or services including but not limited to telephone minutes, upgrades for applications, and limited access videos and songs that may be downloaded to a mobile device. In other embodiments, a user may receive an unspecified token or credit that may be used for a future purchase for a good or service. In still other embodiments, application users can be encouraged to reengage in applications for which they have decreased their usage or in applications that they have ceased using.

### BRIEF DESCRIPTION OF THE FIGURES

FIG. 1 is a flow diagram that represents the initialization step of an embodiment of the present invention.

FIG. 2 is a flow diagram represents display and purchase steps of an embodiment of the present invention.

FIG. 3 is a flow diagram that represents an embodiment of the present invention that is directed to the use of videos for participation in social media.

FIG. 4 is a flow diagram that represents one embodiment of software that communicates with a remote server and an app server in order to authenticate a reward. Communication occurs via an application programming interface (API) callback, whereupon a reward accrues in a user's virtual currency balance.

FIG. 5 is a representation of a timeline flow diagram of the process of FIG. 4.

FIG. 6 is a flow diagram that represents an embodiment of the present invention in which an ad request is used to determine whether reengagement advertising is possible, to determine the best possible type of reengagement call to action and to recording an event that proves a return on investment.

### DETAILED DESCRIPTION OF THE INVENTION

Reference will now be made in detail to embodiments, examples of which are illustrated in the accompanying figures. In the following detailed description, numerous specific details are set forth in order to provide a thorough understanding of the present invention. However, unless otherwise indicated, the details are intended to be examples and should not be deemed to limit the scope of the invention in any way.

Under various embodiments of the present invention, a mobile device runs an application that calls for the display of an advertisement within the application. In these embodiments, the application initiates a computer program product or module that requests an ad from an ad server for an ad configuration. The terms “ad” and “advertisement” are used interchangeably, and refer to the presentation of information to a person for the purpose of inducing the person to act, e.g., to consider an issue, to purchase a product or service or to request more information about a product or service. The phrase “ad configuration” refers to the information that defines which ad to play and when an ad has variable elements (e.g., language, size, extended vs. truncated version, etc.), which of those elements to use. Through the ad configuration data, an ad server, which may be remote and configured to transmit information wirelessly, tells the device that it should play one or more specific ads.

By displaying the images of the video with an application, various embodiments of the present invention transform the display that a user views. Additionally, the data storage files are transformed because new ad data and/or data corresponding to a reward are stored on the wireless devices, e.g., in a non-transitory medium. Further, a reward may be moved from a remote location to the wireless device or other location.

According to one embodiment, the present invention provides a method for obtaining a reward in exchange for displaying a video on a mobile device. This method comprises: (a) displaying an in-application payment advertisement on a mobile device within an application; (b) transmitting a purchase request to a first server, wherein the purchase request comprises data that corresponds to confirmation that the in-application payment advertisement has been displayed on the device; (c) receiving a purchase response from the first server, wherein the purchase response confirms that a distribution of a reward may proceed; and (d) receiving the reward on the mobile device from a second server.

An “in-application payment advertisement” (also referred to as an “in-app payment ad”) is an advertisement that is configured to be displayed within an application and that offers a process through which a user may collect a reward after having viewed an entire video or offers a means by which to commence a process through which a user may collect a reward after having viewed an entire video. By way of one non-limiting example, embedded in a protocol that causes display of the advertisement may be instructions that are automatically executed upon completion of display of the video and that either: (1) immediately and automatically cause transmission of a purchase request to a remote server, or (2) provide a message to be displayed to a user that prompts the user to initiate the transmission of the purchase request to the remote server. Initiation may for example be by a process that involves tapping an icon on a graphic user interface. The protocol may be stored in a non-transitory medium within the mobile device and contain instructions for carrying out the aforementioned steps.

The request that is sent to a remote server may be referred to as a “purchase request,” and the server to which it is sent may be referred to as a “purchase server.” The purchase request may be sent wirelessly or through wired communications and directly to the purchase server or it may be sent wirelessly or through wired communications to an intermediary that relays the message directly or indirectly to the purchase server. The intermediary may, for example, serve as a clearinghouse. The benefit of using a clearinghouse is that the clearinghouse may direct the request to different purchase servers depending on the reward. The purchase server is or is operated by or on behalf of a vendor or service provider.

The purchase request may comprise data that indicates that a video has been viewed in its entirety and that the user of the device is entitled to a reward. The request may also indicate the reward that is being claimed. Optionally, a copy of the purchase request is store in a non-transitory medium of the mobile device. As persons of ordinary skill in the art will recognize, the various embodiments of the present invention can also be configured such that a request is sent when less than all of a video has been viewed, e.g. at least 80% or e.g., 90%. However, advertisers may prefer that each video is played in its entirety and choose to design their embodiments such that only after 100% of a video has been played will a consumer be entitled to a reward.

In various embodiments, the purchase server, after receiving the request, automatically accesses and executes a computer program that verifies that the request is valid and that the request should be fulfilled. Optionally, it checks whether inventory is available and/or whether the reward has already been issued to the device that sent the request, and if so, whether there is a limit on the number times that the same reward may be sent to the same device. In some embodiments, the purchase server also fulfills the request. In other embodiments, the purchase server sends a confirmation to the mobile device that the reward should be fulfilled and the mobile device then contacts a third server that is responsible for fulfilling the reward. Under various embodiments of the present invention the steps of communicating with the second server (the purchase server) and the third server if there is one are performed automatically on the back end through algorithms that are embedded in computer program products that are automatically executed upon completion of viewing of the video and that are stored in non-transitory media.

Fulfillment may, for example, comprise sending the reward, sending a token that corresponds to the reward and/or sending a message that the reward has been sent. The term “token” refers to data that may be in digital form that represents or corresponds to an item. For example, a token may be a credit or other representation that can be exchanged for an item, e.g., virtual currency.

By way of non-limiting examples, if the reward is telephone minutes, the third server might send data to the mobile device for insertion into a mobile or a virtual wallet that is located on the device. If the reward is an upgrade for the application in which the consumer viewed the video, the third server might send computer code to unlock the upgrade, e.g., a new magic spell or weapon within a computer game. If the reward is a physical object such as a piece of clothing, the third server might send a message to the mobile device that the clothing will be or has been sent to a particular address (and optionally request that the user provide a particular address if no address is on file). If the reward is a discount coupon, the third server might send computer data that corresponds to a bar code that can be displayed on the device at a later time. Other examples of rewards include but are not limited to music, additional applications for the mobile device and tickets for entering an event.

In embodiments in which a third server is responsible for fulfilling the reward, analytics can be performed by that server on the purchase request. The analytics may, for example, be performed after receipt of confirmation of entitlement to the reward is received by the device. By performing these analytics, the device can make better choices about the types of videos that the user watches until their completion and the types of rewards that entice the user. The raw data and/or analytic conclusions may also be sent to other servers in order to tailor future advertisements to individuals and certain demographic groups.

Prior to displaying the in-application payment advertisement on the mobile device, the method may further comprise: (a) transmitting a request for an in-application payment advertisement from the mobile device to a third server, wherein the third server comprises or is operably coupled to a database that comprises one or more in-application payment advertisements; and (b) receiving the in-application payment advertisement on the mobile device. Receipt may be directly from the third server or it may be from another source that is instructed by the third server to send it. The phrase “operably coupled” means being able to communicate with, to send information to, and/or to receive information from in a manner that permits devices or modules to perform their intended functions.

The step of transmitting a request described above may occur automatically by the device upon launching of an application or upon launching of a module within an application. In some of these embodiments, the request comprises parameters such as playback features that are required by the application, e.g., operating system, time requirements, data size requirements, video window requirements, device identification (which may be used as a proxy for user identification), ad placement, etc. This data may also include information that corresponds to prior user history and/or demographics of the user. As noted above, analytics may be performed locally on the device that indicate conclusions to be drawn from prior ad viewing history (pertaining to application use and/or rewards claimed) and prior rewards claimed.

Further, in some embodiments, a user may be provided with the option of selecting from geneses or species of rewards. Alternatively or additionally, a user may be provided with options for selecting from geneses or species of ads to be shown. Systems may be configured such that preferences may be input prior to launching of an application or while the application is running.

According to another embodiment, the present invention provides a mobile device for the delivery of video advertisements. The device comprises a computer program product stored in a non-transitory medium, wherein the computer program product comprises: (a) a manager module; (b) a downloader module; (c) a playback module; (d) a purchase request module; (e) a purchase receipt module; and (f) a completion module. Each of these modules may be operably coupled to or able to be operably coupled to any other module or hardware or software that is required in order to assist in allowing the module and the device to function in their intended manners. Further, the device may also comprise a graphic user interface (GUI), a central processing unit (CPU), memory, an input functionality (e.g., a keyboard that is either physical or part of the GUI), optionally an output functionality for sounds, and a portal communication to external servers and networks.

The manager module may be in the form of executable computer code and configured to interact with an application and to prepare a request for data file. The request comprises information corresponding to a zone for a video advertisement within the application.

The downloader module is configured to send the request to a remote server such as an ad server. It is also configured to receive, in response to the request, an ad file that comprises ad data and media assets for an in-application payment advertisement. Further, the downloader module may arrange for local storage of the ad file and any additional formatting that may be needed to facilitate playback of it.

The playback module is configured to cause the mobile device to display a video that corresponds to the in-application payment advertisement. It thus ensures that the ad is played at the appropriate time in the appropriate place.

The purchase request module is configured to send the purchase request to a purchase server. Thus, it makes use of the hardware and software of the device that allows for wireless or wired communication with the purchase server.

The purchase receipt module is configured to receive a validity and success response from the purchase server. It also is responsible for storing the response and if necessary for formatting the response in a manner that permits retrieval of it.

The completion of transaction module is configured to communicate with a remote reward provider and to receive from the remote reward provider a reward. In some embodiments, the completion of transaction module is further configured to transmit to the remote reward provider information that requests transmission of the reward.

Examples of applications in which ads may be played include but are not limited to video games, tutorials and lectures. Within these applications may be one or more places in which an in-application payment advertisement may be displayed.

According to another embodiment, the present invention is directed to a system that provides a reward for viewing a video in an application. The system comprises: a first server, a mobile device, and a second server. The first server is an ad server that comprises or is operably coupled to a database comprising one or more in-application payment advertisements and the ad-server is configured to receive a request from a mobile device. The request comprises one or more playback feature requirements. The mobile device is capable of wirelessly communicating with the server. The purchase server is configured to receive communications from the wireless device and to verify whether a reward is available for viewing the in-application payment advertisement. The purchase server may also be configured to transfer a confirmation that a reward may be released, and/or to transfer the reward itself.

Each of the servers and the mobile device described above comprises the necessary hardware and software to enable them to carry out their intended functions and to be able to communicate through wireless communication systems.

According to another embodiment, the present invention provides a method for obtaining a reward. The method comprises: (a) causing a mobile device to display a video within an application; (b) selecting a set of targets from a contacts database; (c) providing access to the video to the targets through a social-networking application; and (d) receiving a reward after (c). A “social networking application” is an application that permits a person to be in contact with a plurality of other persons and allows one person to share information, data or files simultaneously with a plurality of other persons. A non-limiting example of a social network is Facebook.

Access to the video may, for example, be provided by causing a message that comprises both text and a URL link to be displayed on a social networking site to which the targets have access. This embodiment is described as being of use in connection with rewards for sharing a video after a user has viewed a video within an application. Thus, a user may receive a first reward for having watched a video and may be given the option of a second or greater reward for sharing the video. Additionally, the size of a reward may be determined based on one or more of the number of contacts to whom the video is displayed, the number of messages sent to different contacts requesting that they view the video, and the number of times that the video is viewed by different contacts. Furthermore, the methods may be designed such that social network messages are visible in a social network's applications, on a website, and via other applications and websites using APIs or data feeds of the social network within which they are displayed.

In some embodiments, the system may allow the user to select the set of targets before launching the application, after launching the application and before launching the video or after launching and viewing the video. This third option allows the viewer to maximize the likelihood that the video will be shared only with persons to whom it may be of interest. Additionally, in some embodiments, there may be a protocol that determines how many contacts a person has in order to estimate his or her relative influence with his or her contacts. With this information, the degree to which a reward should be varied can be determined.

As persons of ordinary skill in the art will appreciate, rewards for sharing videos with contacts can be provided outside of the context of in-application viewings.

Various features of these methods, as well as the systems and computer program products that implement them are discussed more fully below, and for illustrative purposes, may be described in conjunction with reference to the accompanying figures of the present application.

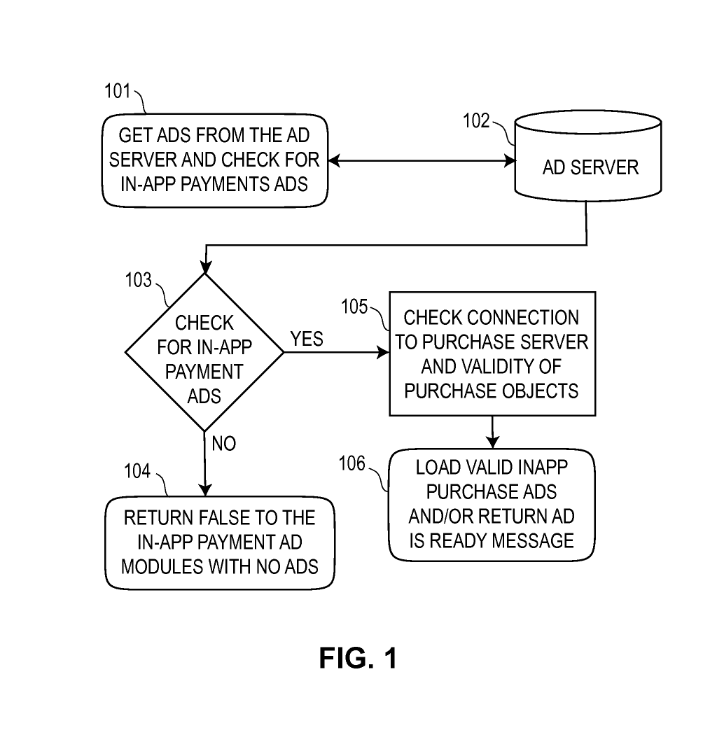

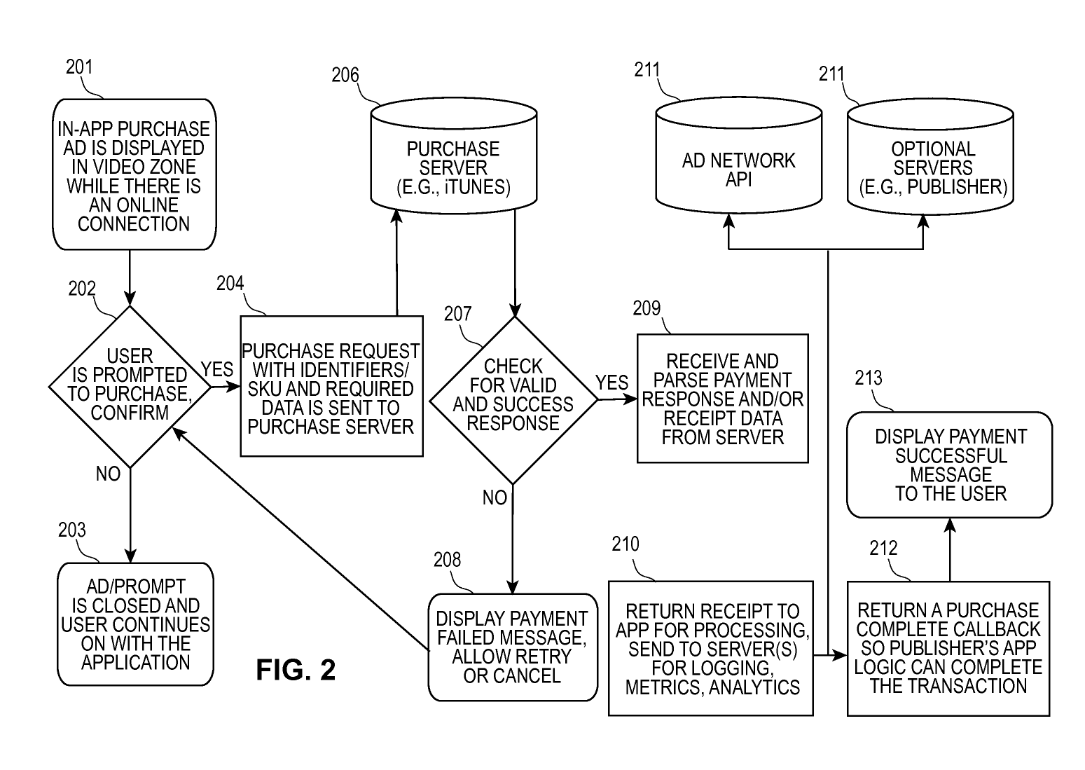

FIGS. 1 and 2 are illustrative of a process in which a button or a hotspot tap on an in-application advertisement will communicate with a native or SDK-based (software development kit-based) payments tool kit for making or receiving digital payments for goods or services. Thus, a user may watch a video within an application and be rewarded for watching the video without being unduly burdened with significant steps for claiming the reward.

Initialization and Remote Communication

Contained in FIG. 1 is a flow chart of the initialization and required communication with a remote server for some embodiments of the present invention. The remote server may, for example, be an ad server. An “ad server” is a computer server, typically a web server that can place advertisements on websites or within an application that is stored on a mobile device. An ad may be presented in the form of an “ad set,” which refers to a pre-bundled set of elements that make up an ad that is to be presented to a plurality or all recipients in the same way. Thus, the ad set may contain at minimum, basic information about how and when an ad should be presented, as well as video, image and/or audio data that is required for the ad presentation.

The ad server stores advertisements that are used in marketing campaigns and the ad server is configured to deliver them to websites or applications that are designed to display the ads. As persons of ordinary skill in the art are aware, the content provided by an ad server is typically updated regularly or irregularly so that over time, an ad that is to be displayed contains new or updated advertisements. These new or updated advertisements may, for example, comprise, consist essentially of or consist of video banners and/or text. Thus, in some embodiments there are advantageous to contacting an ad server proximate in time to when the ad is to be displayed.

Two common types of ad servers are local ad servers and remote ad servers. Local ad servers are typically run by a single publisher and serve ads only to that publisher's domain. One benefit of using a local ad server is that it allows fine grained creative formatting and content that is controlled by that publisher. Remote ad servers are configured to serve ads across domains that are owned by multiple publishers. Accordingly, they can deliver ads from one central source so that advertisers and publishers can track the distribution of their online advertisements and have one location for controlling the rotation and distribution of advertisements across the web. The systems, methods, devices and computer program products of the present invention may be configured to work with local ad servers, remote ad servers or both.

As persons of ordinary skill in the art are aware, ad servers can make use of one or more methodologies for optimizing bid placements, targeting or other characteristics. Examples of these methodologies include, but are not limited to behavioral targeting and contextual targeting. Behavioral targeting refers to the use of a profile of prior behavior of a viewer in order to determine which ad to show at a given time. Contextual targeting (which also may be referred to as semantic targeting) determines the optimum ad placement from information contained on the page or within the application in which the ad is being served.

The phrase “asset server” refers to a computer server that possesses the means of storing and serving static content that populates a virtual world, which by way of non-limiting examples include but are not limited to textures and three dimensional meshes to clothing definitions. Unless otherwise specified or apparent from context, the remote servers described herein may be ad servers that comprise or are associated with asset servers. The servers that function as ad servers and asset servers have one or more protocols that enable the execution of these features and operably couple these features.

As shown in FIG. 1, a mobile device activates a locally stored protocol that starts the process of obtaining one or more ads from the ad server that checks for in-app payment ads 101. Thus, the device is in communication with the ad server 102. After communication with the ad server has been initiated, the ad server checks to see if there are in-app payment ads that may be sent to the device 103. The protocol on the server or the device may be configured such that there is always a preference for selection of in-app payment ads if one exists on the ad server and fits the playback requirements, or a user may be given the option for selecting this preference or there may be random or non-random (e.g., every other or every third ad) display of in-app payment ads and in-app ads that don't allow for payment.

If no such advertisement exists, then a response of false will be returned and no in-app payment ads will be supplied for at that time, 104. Additionally, the protocol may also have a module that checks for duplicative ads and thus even if the ad server has an ad that fits the size and time requirements, if the protocol determines that the ad has previously been viewed or has previously been viewed within a predefined time period or number of uses on the particular device, a false response will also be indicated. If a false response is provided, the protocol may still cause an ad to be displayed, but the ad will not be one that permits the user to purchase goods or services. Additionally or alternatively, there may be a filter stored on the device or on the ad server that prevents downloading or displaying of an ad for a non-consumable product or subscription that has already been purchased by or is in use on the device. An algorithm may be used to query the device as to whether a certain type of ad should be filtered out and thus not displayed or not downloaded.

If the check for in-app payment ad is favorable, a protocol on the device or within the ad server may then verify a connection to a purchase server and the validity of purchase objects 105. A “purchase server” may be distinct from the ad server and be the means through which goods or services may be acquired and/or through which availability is verified. Thus, the purchase server may be the vendor or portal or middleman through which a vendor operates and through which goods or services may be issued. For example, a purchase server may be a vendor that issues currency or credit for iTunes, telephone minutes, cellular telephone applications, etc. By contacting the purchase server at this step, a user will not watch a video only later to learn that he or she will not have earned the currency to purchase a good or service that he or she was led to believe would be acquired by having watched the video.

After having checked the connection to the purchase server and the validity of the purchase objects, the protocol will cause the device to load the valid in-app purchase ad(s) and/or return a message that “an ad is ready” 106. In some embodiments, this message is hidden form the user and only communicated to the device. As persons of ordinary skill in the art will recognize, in some embodiments, the initialization steps shown in FIG. 1 may take place on an as needed basis and thus as a user is running an application, when there is an opportunity for an ad, the protocol is initiated. In other embodiments, the protocol may look for and obtain ads ahead of time and store them locally so that should a user run an application at a time when he or she is in a location for which connection to either the ad server and/or purchase server is not possible, the ad is obtained from what has previously been downloaded and stored locally. Methods for obtaining ads ahead of use are disclosed in U.S. Ser. No. 13/410,855, filed Mar. 2, 2012, the entire disclosure of which is incorporated by reference.

In order to implement the above-described protocol and other protocols described herein on devices such as a mobile device according to the present invention there may be a manager. The manager may be an ad manager, an asset manager or a manager that is both an ad manager and an asset manager, which may be referred to as a combined ad/asset manager and have one or more protocols that enable the execution of these features and operably couples these features.

The ad manager causes the device to load zone information, to set up folders if needed, to download resources lists and to download all resources. The zone information is the set of information that describes the playback for a particular ad placement, e.g., how often the advertisements should play. The phrase “resource list” refers to a set of all resources that are required for playback of an advertisement, and may include media assets and ad data. The folders allow the ad data and media assets to be structured for organizational purposes and to prevent any given advertisement's assets from conflicting with another advertisement's assets. Optionally, the software to run the manager contains threads as structural components. As persons of ordinary skill in the art are aware, a thread is the smallest unit of processing that can be scheduled by an operating system.

The ad manager may provide an interface for an ad rendering component that is received from the server to interact with the device. Additionally, on the device there may also be a software application that facilitates the loading of the ad/asset manager and background downloading of media asset files and managing of files and resources. The software may be organized in the form of a manager module that when executed causes the manager to perform its intended function.

A mobile device of the present invention may, for example, be acellular phone, a mobile device that has wireless telephone capabilities, a tablet or a smart phone (e.g., RIM® Blackberry™ products or Apple® iPhone™ products). These devices preferably have sufficient processing power, display capabilities, and connectivity (either wireless or wired), and the capability to display videos that have been transmitted according to the present invention. Each mobile device may comprise a central processing unit, a graphic user interface and the appropriate tools for establishing communication with, sending information to and receiving information from one or more servers over the internet or other network. Furthermore, each device preferably has sufficient memory capabilities to permit user activity data to be stored until a time that the data may be communicated to a server as described in various embodiments of the present invention. The memory may also store applications and ad data.

The device, may for example, store the information permanently on its persistent storage medium. Under various embodiments of the present invention, this information may remain within the persistent storage medium until the storage medium or the entire invention is uninstalled from a device. Alternatively, information may be stored for a predetermined amount of time and a device may at regular intervals delete the information or within a predetermined amount of time after data has been submitted to an ad server delete the information. When more than one application is configured to obtain and to present ads according to the various embodiments of the present invention, there may be separate storage locales for each application.

Device and User Data Collection

Preferably, each wirelessly internet-connected device has a wireless network adapter or cellular transmitter to communicate with wireless or cellular networks in order to send and to receive data. Software that is installed on a device may be used to extract the device and platform operation system information—such as device type, model, OS, version, Mac address, etc. from the device's internal software/hardware. The software may also track user activity, including but not limited to one or more of frequency and/or time of use of the device, frequency and/or time of use of a particular application, duration of use of a device, duration of use of an application, and duration of display of a video advertisement within an application. This data may be used to track transmissions and assets trafficked between devices and remote ad/asset servers. Relevant registration data may also be collected and transmitted to the ad/asset server to better serve content to that device or user.

Ad Display and Purchase

FIG. 2 provides a flowchart of the steps for ad display and purchase according to an embodiment of the present invention. Here, the in-app purchase ad is displayed in a video zone while there is an on-line connection 201. The user is then prompted to purchase a good or service and optionally may be prompted to confirm the purchase 202. If the user declines to make a purchase, the ad/prompt may be closed and the user will continue with the application that he or she was using 203. Optionally, the system may be configured such that the user may indicate that he or she would like to revisit the issue of making and confirming a purchase at a later time. The later time may, for example, be at a specific time, or within a time window as measured from the time of viewing the ad (e.g., within 2 hours or 2 days).

If the user agrees to a purchase and if required by the protocol confirms the purchase, a purchase request 204 is sent to the purchase server 206. The data in the purchase request may comprise, consist essentially of or consist of one or more of an identifier of the device on which the ad was viewed, an SKU of the good or service to be purchased, an identification of the person who viewed the ad, confirmation that the ad was viewed in its entirety, and a token that corresponds to a value assigned for having viewed the ad.

The protocol waits for a valid and success response from the purchase server 207. A valid and success response is one that may indicate that the transfer of the good(s) or service(s) may proceed because the video was displayed on the device from which the purchase request was sent, and/or the item remains available for purchase and/or there is a connection between the purchaser server and the device on which the video was viewed.

If the valid and success response is negative, the protocol may cause the device to display a message that the payment failed, and optionally either be configured to retry a purchase request automatically or at the user's discretion allow either retry or cancellation of the purchase request 208. If the system is configured to allow for an automatic retry, there may be finite number of retries, e.g., 2-10 or 3-5 until either a positive valid and success response is received or no further retries are performed.

If the valid and success response is positive, the system may receive and parse a payment response and/or receipt data from the purchase server 209. In some embodiments, the mechanisms for completing the transaction are similar to those used for purchasing through an iTunes account or for example through Google Wallet. At this point, the user's device has received a token corresponding to credit that enables receipt of the good or service. Next, the device processes the receipt and optionally sends information to one or more servers for logging, metrics and analytics 210. The metrics and analytics may, for example, be used to show the effectiveness and conversion results of a reward that is offered. The servers that log the data and perform analysis on it may for example be one or more servers operated by an ad server 211 and/or other servers e.g., publishers 212. The data may be used to tailor future ads based popularity and/or based on demographics.

After the receipt has been returned to the app, the protocol on the device may cause the device to return a purchase complete callback to a publisher so that the publisher's application logic can complete the transaction 212.

Finally, the device may be caused to display a payment successful message to the user and thus indicate completion of the purchase 213.

Marketers can use the various embodiments of the present invention in connection with a number of different economic models. For example, a marketer that is responsible for causing an advertisement to be launched within an application can charge the vendor of the advertised product a commission based on each display or a percentage of digital sale amount.

Videos for Participation in Social Media

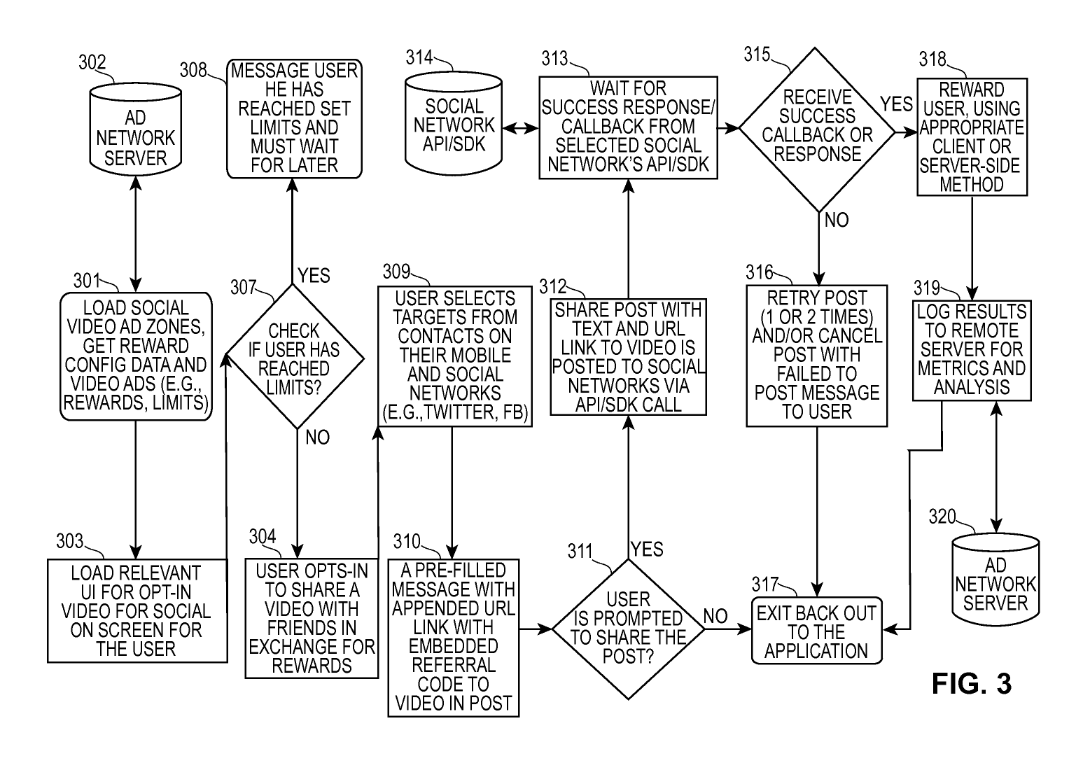

FIG. 3 is a flow chart that shows a process for rewarding the sharing of videos through social media. In this embodiment, a user contacts an ad server such as one operated by AdColony 302, and loads social video ad zones, and gets reward configuration data and video ads 301 that correspond to rewards and limits. The device then loads the relevant user interface (UI) for an opt-in video for social sharing on the screen of the user 303. This step provides a user with the potential for entering an application in which he or she may obtain rewards for sharing a video through social media. Thus, the ad may be displayed in a first application, and then in connection with viewing the ad, the user may access a second application that is a social networking application.

Verification is performed in order to determine if a user has met his or her limits 307. This check may be performed locally, on the server or in a cloud. These limits may be defined by the capacity of hardware or software or they may be defined by the server in order to ensure control of the distribution of videos. If the user has hit his or her limit, a message may be sent to the user and/or to the server that indicates that the user has hit the user's limit 308.

If the user has not hit his or her limit, the user may be given the option to opt-in to sharing the video with friends in exchange for a reward 304. After opting-in, the user may select targets from his or her contacts 309. The contacts may for example be within a social network such as Twitter, Facebook, MySpace, LinkedIn, Flicker, etc.

Next the system may generate a pre-filled message with an appended URL (uniform resource locator) link that contains an embedded referral code that is populated in a post 310. The system may then prompt the user to share the post 311. The user may have the option of declining, in which case he or she may exit back out to the application 317. If the user accepts the invitation to share the post with the text and URL link to the video, then the video may be posted to one or more social networks via an API/SDK call (application programming interface/software development kit call) 312.

The system then waits for a success response/callback from the selected social network's API/SDK 313, which is received 315 from the social network 314. The system may be configured such that if the response is negative, then the system may retry the post, for example, 1 to 10 times or 2 to 5 times or 1 time or 2 times 316. Alternatively, it may only try to post the video once, and if there is failure after the one time, then cancel the post and exit back out to the application 317.

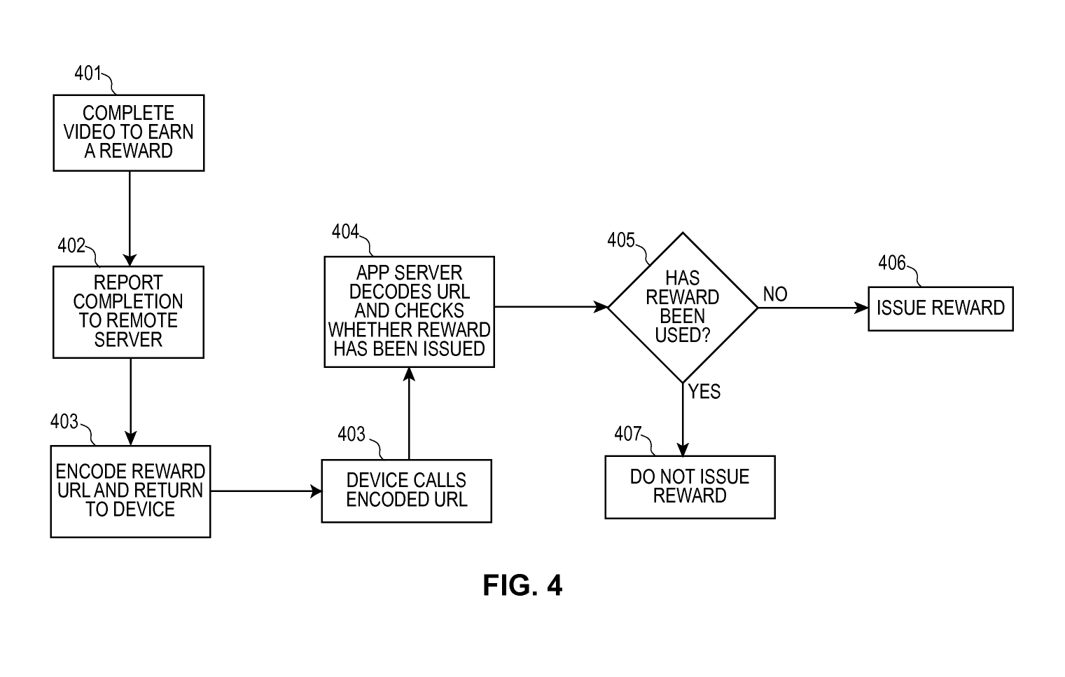

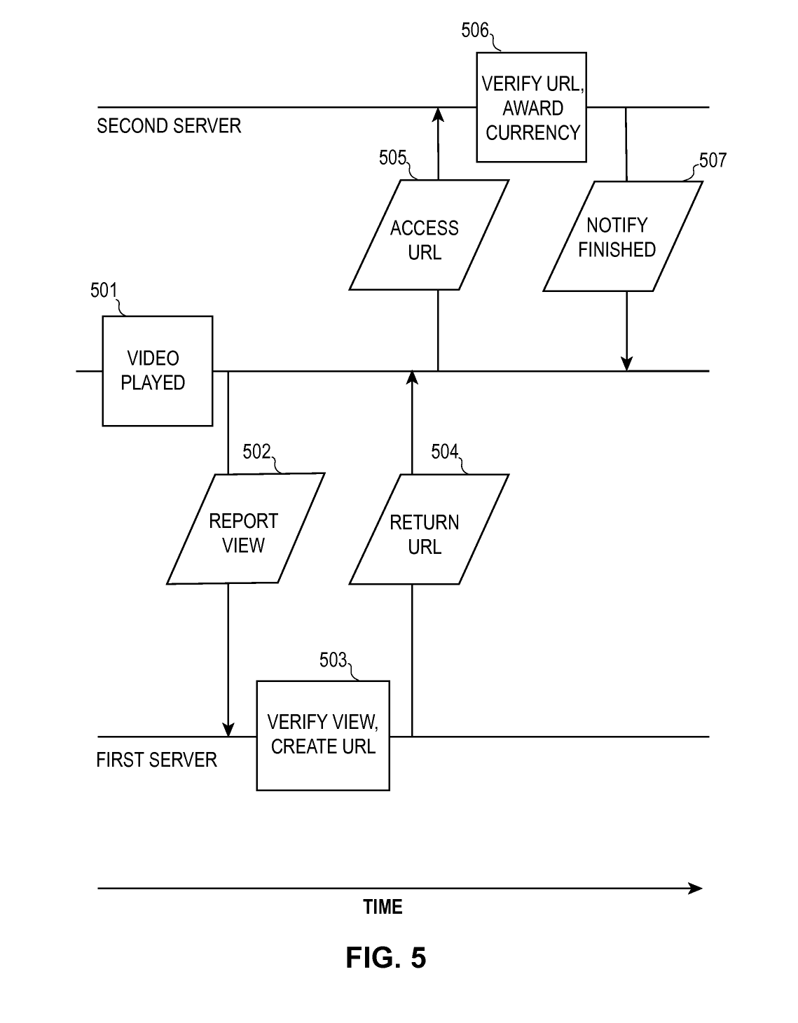

If after contacting the social network, the success callback or response is in the affirmative, then the user may receive a reward 318. The reward may be through a server side or client side method as described below and in FIGS. 4 and 5. After the reward has issued, the system may log to a remote server for metrics and analytics 319, 320. After the results have been logged the system exits back out to the application 317.

As noted above and for ad applications described herein, optionally, locally on a device, remotely on a server or in the cloud there may be an analytics manager. The analytics manager causes the device to track the current session and to report the previous session or sessions if there were any to the server. The tracked data may include one or more if not all of session length, history of viewing a video advertisement, device type, device operating system version and internet connection device. This information may, for example, be sent in Java Script Object Notation (JSON) format or other similar format that may be used to serialize and to transmit structured data over a network connection between for example a server and application.

The information pertaining to the previous session may be presented as raw data or preprocessed prior to transmission in order to put it in a format that is more easily processed by a server. In one embodiment, data is collected and analyzed with respect to the previous session length, the device type and the operating system version. On the server, analysis may be done to summarize the data and to store it for future analytics, e.g., reporting to the application owners, basic metrics about the total number of users, average session length, and total session time. The server may also maintain files that track a device's use over time in order to obtain macro information about a device's use.

Various embodiments of the present invention for obtaining or delivering rewards may be further understood by reference to FIG. 4 and to FIG. 5. FIG. 4 is a flow diagram of one embodiment of communication of a mobile device with a remote server (or first DB) and an app server (or second DB) in order to authenticate a reward. Communication to the app server occurs via an API callback, whereupon a reward occurs in a user's virtual currency balance. Upon accruing of the reward, a success message is sent to the user.

Thus, on the mobile device, after a user has watched a video for which the user is to be rewarded 401, the device generates and sends a report to a remote server e.g., a purchase server or other server(s) (first DB) 402. The report may be referred to as a video impression identifier or purchase request. The report may comprise information that indicates one or more if not all of the playing of the video on the device has been completed, what the video was, what the scheduled reward is and the identity of the device. The remote server verifies the video impression, creates a unique URL and encodes the URL with a secret key.

The remote server 402 sends the encoded URL back to the device 403. The device then calls the URL that it received and accesses the app server 408. The app server decodes the URL with the secret key, and checks to see if the video impression identifier has or has not been used 404. Optionally, the secret key is communicated directly between the first server and the second server. Next, a determination is made as whether a reward has been used 405. If the video impression identifier has not yet been used, the app server returns a message of success and updates the user balance 406, thereby issuing a reward. If the video impression identifier has been used already, the app server returns a message of decline and does not change the user balance of virtual currency 407. This latter step can be used to ensure that rewards are not provided to a user who watches the same video multiple times. As persons of ordinary skill in the art will recognize, each video impression identifier may be unique so that users of different devices can each receive virtual currency for watching the same video.

The system may be designed such that upon receipt of a success message, the device contacts a publisher or entity who may record that the video was watched. The system may also display that that the user received the reward 403. The entity that tracks viewing of an advertisement may use the data to design future advertising campaigns. Of particular interest to these entities may be one or more of the number of views of the video by different persons, the time of the viewing, the location of the viewing, etc.

FIG. 5 represents a timeline of the activities described above in connection with FIG. 4. In FIG. 5, a video is played on a mobile device 501. The device sends a report of the completion of the viewing of the device to first server 502. The first server verifies that the video has been viewed and creates a URL 503. The URL is returned to the device 504. The device accesses the URL on the second server (which may be a developer server) 505. On the second server, there is verification of the URL, and a determination is made as to whether to reward currency 506. After a determination is made, the device is notified of the decision 507, which may be displayed on a graphic user interface of the device to a user.

Because of the potential to find a captive audience, marketers may seek to provide users with applications for free and then be able to control the ads that the users see within the videos. The ability to control ad placement and analyze data based on ads viewed will provide marketers with an ability to improve efficiency of their marketing endeavors.

According to another embodiment, the present invention provides a method for targeting and reengaging inactive users of an application. This method may be used in conjunction with or independent of the other embodiments of the present invention provided above. In this method, an inactive user of an application is a user who has not used a particular application within a specified amount of time or has used the application with less than a specified frequency within a specified time period or has used the application with a certain reduction in frequency within a specified time period or a combination thereof.

By way of a non-limiting example, in some embodiments, an inactive user may be defined as a user who has not used a particular application within a predefined period of one day, one week, two weeks, one month, two months, three months, etc. Thus, the last time that the user used the application was more than the specified amount of time counting back from the time at which activity is measured.

In other embodiments, an inactive user may be defined as a user who has used a particular application fewer that X number of times within time period Y. For example the user may have used the application fewer than 3 times within a week or fewer than 10 times within a month.

In still further embodiments, an inactive user may be defined as a person who has decreased his or her use of an application by more than A % within time period B. For example, the user may have used the application at least 33% less over the course of a week as compared to the previous week. Thus, in some embodiments, an inactive user is a user who may still be using the application, but is doing so less frequently than he or she has in the past, even though he or she might not have completely abandoned usage of it.

According to this embodiment, the method identifies a segment of users who are less active than the users were at a previous time. This reduced activity may be a measure of the number of times that an application has been launched or the amount of time spent within the application or a combination thereof. Preferably, activity is monitored by a computer through the application of an algorithm that is stored locally or remotely in a non-transitory medium or in the cloud.

A system may track information relating to when the application has last been used, how frequently it has been used and/or how often it has been used. Methods for tracking usage of applications on computing devices, including but not limited to usage on smart phones are well-known to persons of ordinary skill in the art.

After usage of an application is determined, a segment of owners of an application who are defined as being sufficiently inactive is found. To these users, a reengagement video may be sent or an offer for the reengagement video may be sent. The application with respect to which the user has been determined to be inactive may be referred to as a first application. The reengagement video may be configured to be displayed within a second application and either automatically or after acceptance by the user, it may be caused to be displayed within the second application.

In some embodiments, the video comprises one or more reengagement features that facilitate reengagement of the first application. These features may comprise one or more of a reinstallation feature, which will cause the inactive application to be reinstalled; an update feature, which will cause the application to be updated; or an open the application feature, which when launched will cause the inactive application to launch. Furthermore, the reinstall, update and open features may be ones from which the user has the option of selecting or they may be linked such that the user opts to reengage and automatically, a check is made in order to determine whether the most recent version is present, whether updates are needed, whether reinstallation is needed or whether the application as present may be launched and the necessary steps for launch the most recent version with the most recent updates are set in motion. The method may be configured such that the launch occurs instantaneously, the launch occurs immediately after the user closes the second application, or the user is prompted with a query that asks when he or she would prefer to launch or whether he or she would prefer to launch the application himself or herself at a later time.

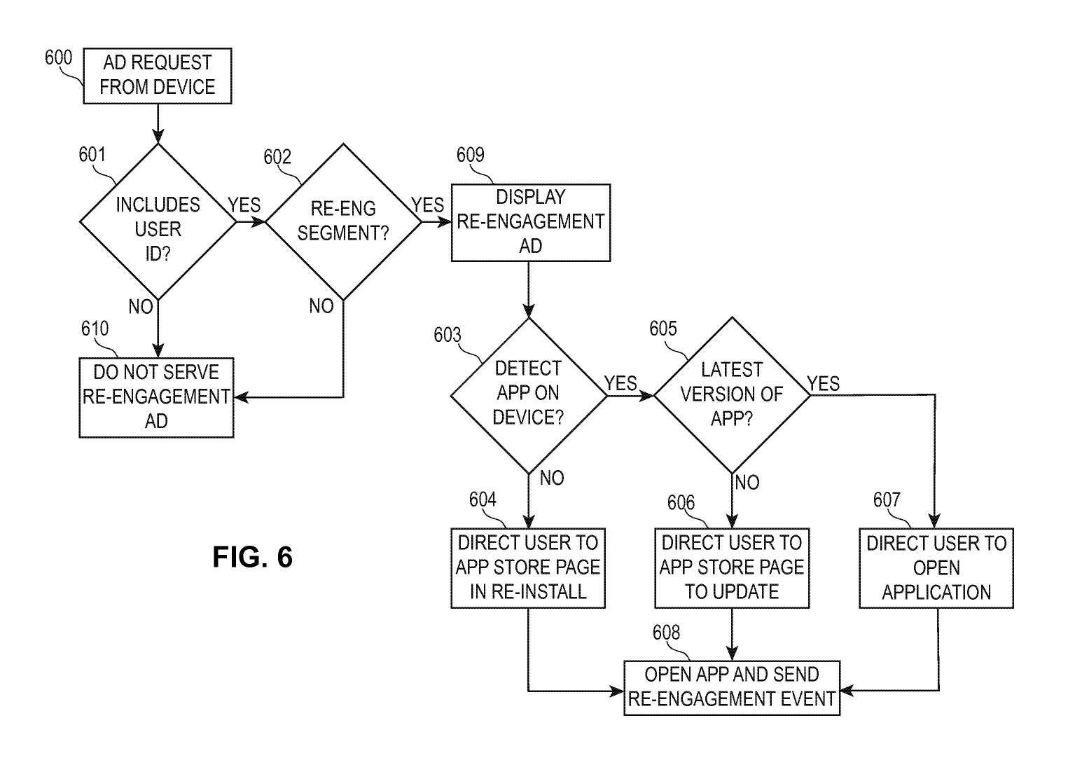

FIG. 6 provides a flowchart of the steps for ad display and re-engagement of some embodiments of the present invention. As illustrated, a reengagement ad is requested by a device 600. This request may, for example, be made because the device determines that there is an inactive application (a first application) on the device and/or a second application is in need of a video for display. A check is made to determine whether the request contains a User ID 601. If no User ID is contained within the request, then no reengagement ad will be sent 610.

If the User ID is available, then that User ID will be checked against a segmentation database to determine whether the User ID is part of a defined reengagement segment 602, i.e., if it is part of the set of User IDs that correspond to users to which reengagement ads (e.g., videos) should be sent. If so, the user may be presented with a reengagement ad targeted to the segment to which they belong 609. Thus, a video offering or encouraging reengagement of an inactive application may be sent for display in an active application. If the User ID is not part of the set for which reengagement is being offered, the user is presented with another type of advertisement and no reengagement ad is sent 610.

After the ad is shown, if the user indicates that he or she wishes to reengage, the method may determine whether it is possible to detect whether the inactive application is currently installed on the device 603. If the application is not detected, or if detection is not possible, the user is directed to the app store page for the application 604.

If the app is currently detected as installed on device, the system tries to determine which version of the application is installed 605. If the version cannot be detected, or if the version represents an older version of the application, the user is presented with an option to update the application and directed to the appropriate app store page, or other appropriate location, for updating 604, 606. If the installed version represents the latest version, the user is presented with an option to open the application 607. If this is not possible, based on the device or OS limitations, the user can be directed to the default app store page, or other appropriate update location 606.

After the application is opened, an event is sent to an event server to record both the User ID and application ID, and optionally additional information such as time of launch and location of the user at reengagement 608. This information can be matched against events related to user exposure to the advertisement and user clicks on the ad (to install, update, or open) to demonstrate the ad's effectiveness in driving users in the inactive segment to return to the application.

The method may make use of one or more algorithms for determining in which second application to cause the video to be displayed. For example, the method may access one or more databases that store a plurality of applications that a user has associated with (or downloaded on) his or her computing device (e.g., smartphone). For any inactive application that is associated with a user, the system may look for an application that: (A)(i) is currently being used; (ii) has recently been used and optionally, with a certain frequency; or (iii) is likely to be used within a predefined amount of time; and (B) is configured to receive and to display videos such as those described in this specification and/or in U.S. Ser. No. 13/410,885, filed Mar. 2, 2012, the entire disclosure of which is incorporated by reference.

According to another embodiment, the present invention provides a system for segmenting and targeting inactive users of an application or a subset of users of an application. The system comprises a first server, a wireless device and a second server.

The first server may be an ad server that comprises or is operably coupled to a database comprising user segments of active users and inactive users of one or more applications. A “segment” as used herein refers to a piece of information that identifies a characteristic of a user. User segments can form groupings that correspond to users that have something in common, e.g., usage patterns or possession of certain applications on a mobile device or past history with reengagement or purchasing history. By using one or more of these grouping, and targeting videos to the segmented users, application publishers may be able to achieve a higher return on their efforts.

The ad-server is configured to receive a request from a mobile device. The request comprises one or more playback feature requirements for a video. The ad server is capable locating and transmitting to the mobile device, a video that is or is part of a targeting reengagement campaign. Being part of a targeting reengagement campaign, the video is configured to encourage and/or facilitate the reengagement of a user of a reengagement video with an inactive application. Accordingly, the system is configured to send the video to users who have been inactive with respect to said one or more applications.

The wireless device is capable of wirelessly communicating with the first server, information that comprises a user identifier that can be correlated with a database of user segments. Preferably, the wireless device is capable of activating a feature within the reengagement video to start the process of reengaging an inactive application.

The system also comprises a second server. The second server is an event server that is configured to receive communications from the wireless device and to verify whether an application has been reinstalled, updated, or opened. The second server may perform analytics on these communications to determine whether reengagement activities worked and with what efficiency. In performing the analytics, the system may take into account the inactive application, the second application, the video, the profile of the user, time of day of the reengagement campaign and the selected method for reengagement.

According to another embodiment, the present invention provides a method for segmenting users. By segmenting users, the method groups them by common features in order to organize users who share similar features into groups. Accordingly, in this method, a system may receive first-party data, wherein the first-party data comprises one or more of usage logs and events and in-app purchase data. This first party data may be received directly from the mobile devices of users or from another entity that collects the data.

In this method, one also receives data comprising a unique identifier for each user. The unique identifier may, for example, comprise at least one of a device ID or a user ID.

Either prior to or after receiving the first-party data and the unique identifier, one (e.g., a computer algorithm stored on a non-transitory medium) segments a plurality of users into a set of active users and a set of inactive users. By way of a non-limiting example, the set of active users and the set of inactive users may be defined by a usage pattern of a specified application or a specified set of applications.

Optionally, one (e.g., a computer program product) sends a video for reengagement to the set of inactive users. Alternatively, one further segments users within either or both the set of active users and the set of inactive users based on at least one of average daily usage or in-app purchase history to form further segmented sets of users.

For simplicity, the aforementioned method is described in terms of receiving first-party data, which is data that an SDK may transmit directly from a device to an entity or system for analysis and/or processing. However, in some applications publishers may prefer that the entity that engages in segmentation is not able to identify the device or user from which data is obtained. Accordingly, the publisher, which may be referred to as a third party may first process some of the data that is received from users or their devices and send that processed data for segmentation. The processing may, for example, comprise a step in which the data is rendered anonymous or coded so that only the publisher knows the identity of the user or the user's device. In this case the video for reengagement may be sent back through the publisher so that the publisher can ensure that it reaches the appropriate user. Additional examples of third party data are compilations or histories of usage of applications or purchases within applications of individuals or groups of individuals. In some embodiments, some or all data may be sent through third parties and thus be third-party data. Similarly, some or all data may be sent directly from the SDK of devices and be first-party data.

According to another method of the present invention, one can reengage users of an inactive application on a computing device by segmenting the users as described above and sending a video to users within the segmented set or within a further segmented set of users. The video is preferably configured to encourage reengagement of a first application and to be displayed within a second application, wherein the first application is an inactive application and the video is configured to offer each user within the further segmented set of users an option of at least one of reinstalling the first application, updating the first or opening the first application. The user may be permitted to respond with a request to reengage, and following receipt of an instruction to reengage, the first application is caused to become active or the user is provided with an option of determining when the user wishes for it sot become active.

Optionally, after an inactive application is reengaged and thus no longer inactive, one may engage in any of the embodiments of the present invention for offering rewards or purchases and/or sharing though social media through that application.

The methods of the current invention may be embodied in one or more protocols that are stored in one or more executable computer program products and tools for creating these technologies may be embodied in a software development kit. The computer program products may, for example, be stored as part of software, hardware or a combination thereof in a non-transitory storage medium. Furthermore, various embodiments of the present invention may be parts of systems that comprise one or more mobile devices and one or more servers. The mobile devices may be configured to communicate with one or more servers through technologies that are now known or that come to be known to persons of ordinary skill in the art for accessing a server through a network such as the worldwide web.

Within this disclosure, reference is made to storage on non-transitory tangible computer readable storage mediums or non-transitory media or medium. A “non-transitory tangible computer readable storage medium” or “non-transitory media” may also be referred to as a computer program product, and includes hardware, software or a combination of the two on which one may store a set of instructions that may be used to direct a computer to perform a set of steps. Examples of non-transitory tangible computer readable storage medium include, but are not limited to, a hard drive, a hard disk, a floppy disk, a thumb drive, a computer tape, ROM, EEPROM, nonvolatile RAM, CD-ROM and a punch card. Thus, in some embodiments the instructions are software stored on a medium that can instruct a computer having one or more of the following hardware components: memory, storage, an input device, an output device and a central processing unit.

The term “module” as used in this disclosure refers to a computer program product that may be stored on hardware and/or software that may be activated by a user to carry out a defined set of steps and/or to prompt a user to provide information through, for example, a graphic user interface and/or input/output device. Thus, a module may be stored in the form of a tangible medium. For convenience, various features are described herein as being different modules. However, as persons of ordinary skill in the art will readily recognize, different modules may be part of the same of different computer program products that are configured to interact with each other.

Additionally, the methods, systems and computer program products are preferably configured such that any data that is collected, transmitted and/or saved is appropriately protected against undesirable invasions of privacy. For example, the systems can be designed such that only authorized personnel have access to any data that is collected, and/or the data is automatically deleted after a predetermined amount of time, e.g., two weeks, one month or six months. Alternatively, data may be collected and rendered anonymous.

Any of the features of the various embodiments described herein can be used in conjunction with features described in connection with any other embodiments disclosed unless otherwise specified. Thus, features described in connection with the various or specific embodiments are not to be construed as not suitable in connection with other embodiments disclosed herein unless such exclusivity is explicitly stated or implicit from context.

We claim:

1. A method for obtaining a reward in exchange for displaying a video on a mobile device, said method comprising:
(a) displaying an in-application payment advertisement on a mobile device within an application;
(b) transmitting a purchase request to a first server, wherein the purchase request comprises data that corresponds to confirmation that the in-application payment advertisement has been displayed on the device;
(c) receiving a purchase response from the first server, wherein the purchase response confirms that distribution of a reward may proceed; and
(d) receiving the reward on the mobile device from a second server.

2. The method according to claim 1, wherein prior to displaying the in-application payment advertisement on the mobile device, the method further comprises:
(a) transmitting a request for an in-application payment advertisement from the mobile device to a third server, wherein the third server comprises or is operably coupled to a database that comprises one or more in-application payment advertisements; and
b) receiving the in-application payment advertisement on the mobile device.

3. The method according to claim 2, wherein the request comprises data that corresponds to one or more playback feature requirements for an in-application video.

4. The method according to claim 1, wherein the reward is a token that denotes entitlement to a good or a service.

5. The method according to claim 4, wherein the good or the service comprises telephone minutes.

6. The method according to claim 1, wherein the reward is an upgrade for the application.

7. The method according to claim 1, wherein the application of (a) is a first application and the reward is a second application.

8. The method according to claim 3, wherein the request further comprises platform operation system information.

9. The method according to claim 1, wherein the application is a video game.

10. The method of claim 4 further comprising storing the token in a virtual wallet.

11. A mobile device for receipt of video advertisements comprising a computer program product stored in a non-transitory medium, wherein said computer program product comprises:
(a) a manager module, wherein the manager module is configured to interact with an application and to prepare a request for a data file, wherein said request comprises information corresponding to a zone for a video advertisement within the application;
(b) a downloader module, wherein the downloader module is configured to send the request to a remote server, and to receive in response to the request an ad file that comprises ad data and media assets for an in-application payment advertisement;
(c) a playback module, wherein the playback module is configured to cause the mobile device to display a video that corresponds to the in-application payment advertisement;
(d) a purchase request module, wherein the purchase request module is configured to transmit a purchase request to a purchase server;
(e) a purchase receipt module, wherein the purchase receipt module is configured to receive a validity and success response from the purchase server; and
(f) a completion of transaction module, wherein the completion of transaction module is configured to communicate with a remote reward provider and to receive a reward from said remote reward provider.

12. The device of claim 11, wherein the completion of transaction module is further configured to transmit information that requests transmission of the reward to the remote server provider.

13. The mobile device of claim 11, wherein the application is a video game.

14. A system for providing a reward for viewing a video in an application, said system comprising:
(a) a first server, wherein the first server is an ad server that comprises or is operably coupled to a database comprising one or more in-application payment advertisements and the first server is configured to receive a request from a mobile device, wherein the request comprises one or more playback feature requirements;
b) the mobile device, wherein the mobile device is capable of wirelessly communicating with the first server; and
(c) a second server, wherein the second server is a purchase server and is configured to receive communications from the wireless device and to verify whether a reward is available for viewing the in-application payment advertisement.

15. A method for obtaining a reward comprising:
(a) causing a mobile device to display an advertisement within an application;
(b) selecting a set of targets from a contacts database;
(c) providing access to the video to the set of targets through a social networking application; and
(d) receiving a reward after (c).

16. The method according to claim 15, wherein the reward is a token that denotes entitlement to a good or a service.

17. The method according to claim 15, wherein the providing is by causing a message that comprises both text and a URL link to be displayed on a social networking site to which the targets have access.

18. The method according to claim 15, wherein the reward is virtual currency.

19. The method according to claim 15, wherein the reward is a token that denotes entitlement to a good or a service.

20. A mobile device comprising a graphic user interface and a computer program product stored in a non-transitory medium, wherein said computer program product comprises automated instructions to carry out the steps of the method of claim 15.

21. A method for targeting and re-engaging inactive users of an application, said method comprising:
(a) identifying a set of users who are less active than the users were at a previous time;
(b) transmitting a reengagement video to the set of users;
(c) offering a reengagement action to the set users; and
(d) enabling the users to activate the reengagement action.

22. The method according to claim 21, wherein the reengagement action is selected from the group consisting of reinstall, update, or open the application.

23. The method according to claim 22, wherein the application is a first application and the video is configured to be displayed within a second application.

24. A system for segmenting and targeting inactive users of an application or a subset of users of an application, said system comprising:
(a) a first server, wherein the first server is an ad server that comprises or is operably coupled to a database comprising user segments of active and inactive users of one or more applications and the ad-server is configured to receive a request from a wireless device, wherein the request comprises one or more playback feature requirements and the ad server is capable of targeting reengagement campaigns to users who have been inactive with respect to said one or more applications;
(b) the wireless device, wherein the wireless device is capable of wirelessly communicating with the first server information that comprises an identifier that can be matched against the database of user segments; and
(c) a second server, wherein the second server is an event server, wherein the event server is configured to receive communications from the wireless device and to verify whether an application has been reinstalled, updated, or opened.

25. A method for segmenting users, said method comprising:
(a) receiving one or more of usage logs and events and in-app purchase data;
(b) receiving a unique identifier for each user;
(c) segmenting a plurality of users into a set of active users and a set of inactive users to form segmented sets of users; and
(d) further segmenting users by the unique identifier of each user within either or both the set of active users and the set of inactive users based on at least one of average usage over a time period or in-app purchase history to form further segmented sets of users.

26. The method according to claim 25, wherein the unique identifier comprises at least one of a device ID or a user ID.

27. The method according to claim 25, wherein said set of active users and said set of inactive users are defined by a usage pattern of a specified application or a specified set of applications.

28. The method according to claim 25, wherein at least one of the unique identifier or the usage logs and events and in-app purchase data is third-party data.

29. A method of reengaging users of an inactive application on a computing device, said method comprising the method of claim 27, wherein the application is a first application and said method further comprises:
(a) sending a video to users within a further segmented set of users, wherein the video is configured to be displayed within a second application, wherein the first application is an inactive application and the video is configured to offer each user within the further segmented to reengage the first application; and
(b) causing the first application to become active.

30. The method according to claim 29, wherein the computing device is mobile telephone.
